(19) United States
(12) Patent Application Publication
(10) Pub. No.: US 2011/0009165 A1
(43) Pub. Date: Jan. 13, 2011

(54) Electronic System with Extended Functions and Method Thereof

(76) Inventors: Chun-Chung Hung, Taipei Hsien (TW); Hou-Cheng Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/730,212

(22) Filed: Mar. 23, 2010

(30) Foreign Application Priority Data
Jul. 10, 2009 (TW) 098123315

(51) Int. Cl. H04W 88/02

(52) U.S. Cl. 455/557

(57) ABSTRACT

The present invention provides an electronic system with extended functions, which includes a first electronic device and a second electronic device. The first electronic device and the second electronic device can be coupled to each other via a first transmission interface and a second transmission interface, to achieve an extended function by utilizing original elements of the first electronic device via operation program stored in the second electronic device.

### BACKGROUND OF THE INVENTION

1. Field of the Invention

The present invention relates to an electronic system with extended functions and method thereof, and more particularly, to an electronic system and related method capable of achieving environment protection and effectively using resources.

2. Description of the Prior Art

With the advancement of technology, portable electronic products, such as mobile phones or PDAs, are frequently upgraded and modified for attracting a customer to buy a new one. However, when the customer uses a new mobile phone instead of the old one or the old mobile phone has a breakdown, the old mobile phone becomes useless and results in recycling or idling. Such way is harmful to environment, wastes resources, and opposes to the trend of energy saving and carbon reduction, so it must be improved.

### SUMMARY OF THE INVENTION

It is therefore an objective of the present invention to provide an electronic system with extended functions and method thereof.

The present invention discloses an electronic system with extended functions comprising a first electronic device and a second electronic device. The first electronic device comprises a first transmission interface, a function module for executing a first function and a control module. The control module is coupled to the first transmission interface and the function module, for controlling the first transmission interface and the function module. The second electronic device comprises a second transmission interface coupled to the first transmission interface for exchanging signals with the first electronic device, and a storage module coupled to the second transmission interface for storing an operation program. The control module controls the function module to execute a second function according to the operation program stored in the storage module, when the second transmission interface is coupled to the first transmission interface.

The present invention further discloses a method for a first electronic device with extended functions. The first electronic device executes a first function. The method comprises the steps of a second electronic device storing an operation program corresponding to a second function, and the first electronic device executing the second function according to the operation program, when the second electronic device is coupled to the first electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of an electronic system according to an embodiment of the present invention.

FIG. 2, FIG. 3 and FIG. 4 are schematic diagrams of a function module shown in FIG. 1 according to embodiments of the present invention.

FIG. 5 is a schematic diagram of a control module shown in FIG. 1 according to an embodiment of the present invention.

FIG. 6 is a schematic diagram of a storage module shown in FIG. 1 according to an embodiment of the present invention.

FIG. 7 is a schematic diagram of an operation procedure according to an embodiment of the present invention.

### DETAILED DESCRIPTION

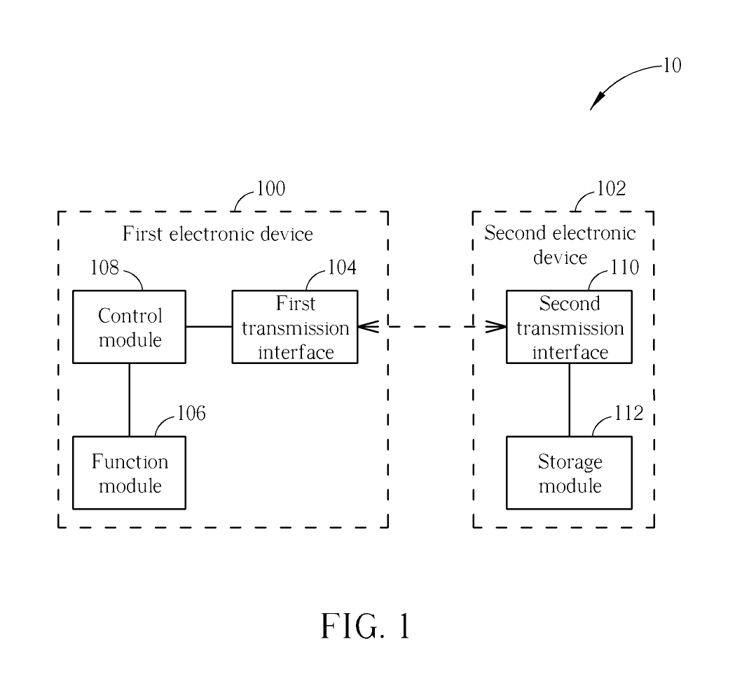

Please refer to FIG. 1, which is a functional block diagram of an electronic system 10 according to an embodiment of the present invention. The electronic system 10 has extended functions and comprises a first electronic device 100 and a second electronic device 102. The first electronic device 100 can be a portable electronic product, such as mobile phone or PDA, and comprises a first transmission interface 104, a function module 106 and a control module 108. The function module 106 executes a first function. The control module 108 controls the first transmission interface 104 and the function module 106. The second electronic device 102 can be a memory card or a device with a memory function, such as a docking station or a mounting element, and comprises a second transmission interface 110 and a storage module 112. The second transmission interface 110 matches with the first transmission interface 104, and is used to couple the first transmission interface 104, such that the first electronic device 100 can exchange signals with the second electronic device 102. The storage module 112 is coupled to the second transmission interface 110, and stores an operation program corresponding to a second function.

In the electronic system 10, when the first transmission interface 104 is not coupled to the second transmission interface 110, the function module 106 executes the first function. On the other hand, when the first transmission interface 104 is coupled to the second transmission interface 110, the control module 108 controls the function module 106 to execute the second function according to the operation program stored in the storage module 112. In short, when the first transmission interface 104 is coupled to the second transmission interface 110, the function module 106 executes the extended function (i.e. the second function) instead of the original function (i.e. the first function). In this situation, the first electronic device 100 can extend the functions and exploit the usage range. As a result, if the customer purchases a new mobile phone, the old mobile phone can still be useful by extending the functions according to the above-mentioned mechanism, so as to help environmental protection and enhance resource recycling.

Note that the electronic system 10 shown in FIG. 1 is used to describe the concept of the present invention, and those skilled in the art can make alterations or modifications accordingly. For example, in the electronic system 10, the interface types of the first transmission interface 104 and the second transmission interface 110 are not restricted, and can be any interface type as long as the first transmission interface 104 and the second transmission interface 110 are matching to each other. For use of wire communication, the first transmission interface 104 and the second transmission interface 110 can meet the interface specifications of USB, PCMCIA, IEEE 1394,SPI, etc. For use of wireless communication, the first transmission interface 104 and the second transmission interface 110 can meet the interface specifications of Bluetooth, WLAN, etc.

Furthermore, the power supply method of the second electronic device 102 needs to be changed according to the corresponding interface types. If the first transmission interface 104 and the second transmission interface 110 exchange signals via wire communication, there are three kinds of methods to supply power to the first electronic device 100 and the second electronic device 102. The first power supply method is: except for supplying power to the first transmission interface 104, the function module 106 and the control module 108, the power supply module (not shown in FIG. 1) of the first electronic device 100 can further supply power to the second electronic device 102 (or specifically, the second transmission interface 110 and the storage module 112) via a connecting cable between the second transmission interface 110 and the first transmission interface 104, as the second transmission interface 110 is coupled to the first transmission interface 104. The second power supply method is: except for supplying power to the first transmission interface 104, the function module 106 and the control module 108, the power supply module of the first electronic device 100 can further supply power to the second electronic device 102 (or specifically, the second transmission interface 110 and the storage module 112) by an electromagnetic induction method. The third power supply method is: the first electronic device 100 and the second electronic device 102 have their own power supply modules to separately supply power if necessary. On the other hand, if the first transmission interface 104 and the second transmission interface 110 exchange signals via wireless communication, the first electronic device 100 and the second electronic device 102 can be powered by the second and third power supply methods mentioned above.

Furthermore, in the above description, the first function is the executable original function for the function module 106, while the second function is the extended function achieved by the function module 106 when the second electronic device 102 is connected to the first electronic device 100. Therefore, designing the second function, those skilled in the art should consider components of the function module 106, in order to design a suitable extended function.

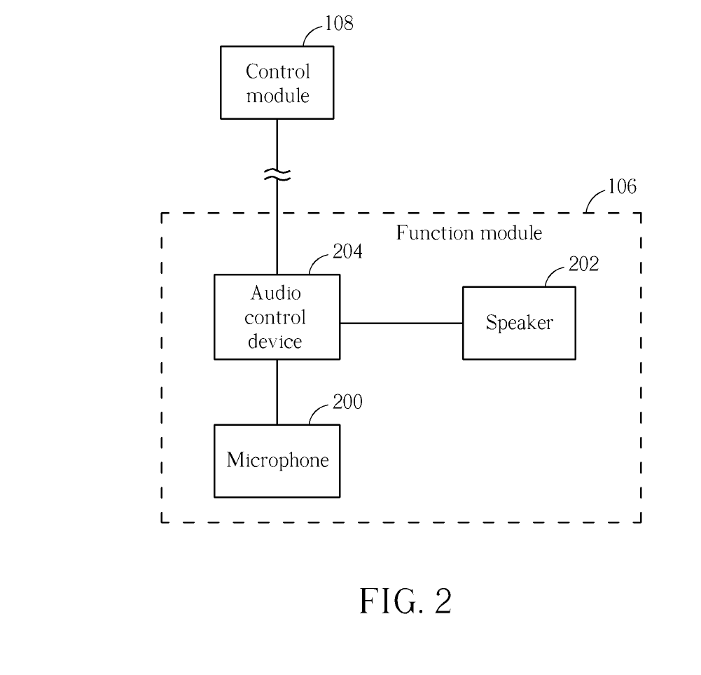

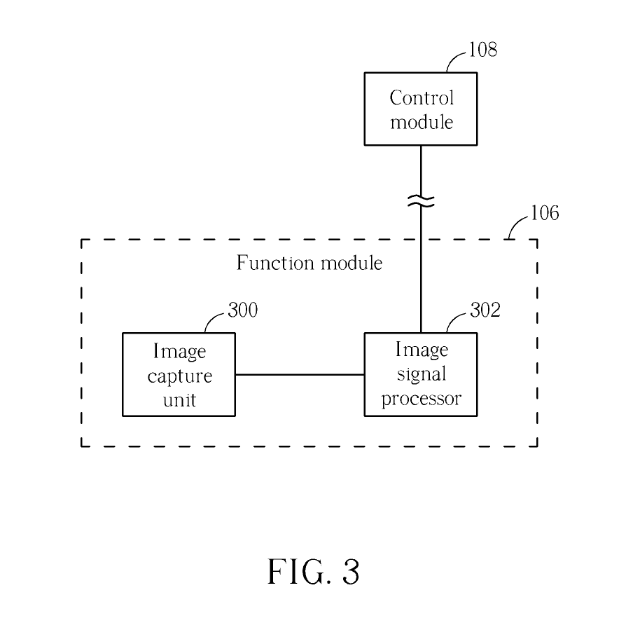

For example, as shown in FIG. 2, if the function module 106 comprises a microphone 200, a speaker 202 and an audio control device 204, and executes a voice signal processing function, the electronic system 10 can achieve an alarm function with a suitably designed program stored in the storage module 112. In other words, when the first transmission interface 104 is coupled to the second transmission interface 110, the control module 108 controls the audio control device 204 to drive the speaker 202 to output an alarm signal when a volume of voice signals received by the microphone 200 is greater than a predefined value according to the program stored in the storage module 112. In this situation, when the electronic system 10 is set at a suitable place, an alarm function is achieved.

Furthermore, as shown in FIG. 3, if the function module 106 comprises an image capture unit 300 and an image signal processor 302, and the image signal processor 302 processes image signals captured by the image capture unit 300 to execute an image processing function, the electronic system 10 can achieve an automatic recording function with a suitably designed program stored in the storage module 112. That is, when the first transmission interface 104 is coupled to the second transmission interface 110, the control module 108 drives the image capture unit 300 to record the captured image signals when a processing result of the image signal processor 302 indicates that a variation degree of the image signals captured by the image capture unit 300 is greater than a predefined value according to the program stored in the storage module 112. In other words, when the variation degree between image signals currently and previously captured by the image capture unit 300 is greater than a predefined value, the control module 108 can drive the image capture unit 300 to record the captured image signal. As a result, when the electronic system 10 is located at a suitable place, an automatic recording function is achieved, so as to enhance security or reach home care services.

In addition, as shown in FIG. 4, if the function module 106 comprises a clock generator 400 and a timing control unit 402, and executes a clock generating function, the electronic system 10 can achieve a timing function with a suitably designed program stored in the storage module 112. In other words, when the first transmission interface 104 is coupled to the second transmission interface 110, the control module 108 controls the timing control unit 402 to count time based on the clock signal generated by the clock generator 400 according to the program stored in the storage module 112. As a result, the electronic system 10 can achieve a timing function. Moreover, if the function module 106 comprises a display module, the control module 108 can control the display module to display the timing result provided by the timing control unit 402.

FIG. 2 to FIG. 4 are used to illustrate exemplary embodiments of the function module 106, in order to specify the concept of the present invention is not related to how to achieve the function module 106 but to achieve the extended function beyond the original functions by utilizing all the components in the function module 106 via the program of the second electronic device 102. Therefore, modifications or variations based on the concept of the present invention are included in the scope of the present invention, and not limited to above-mentioned examples.

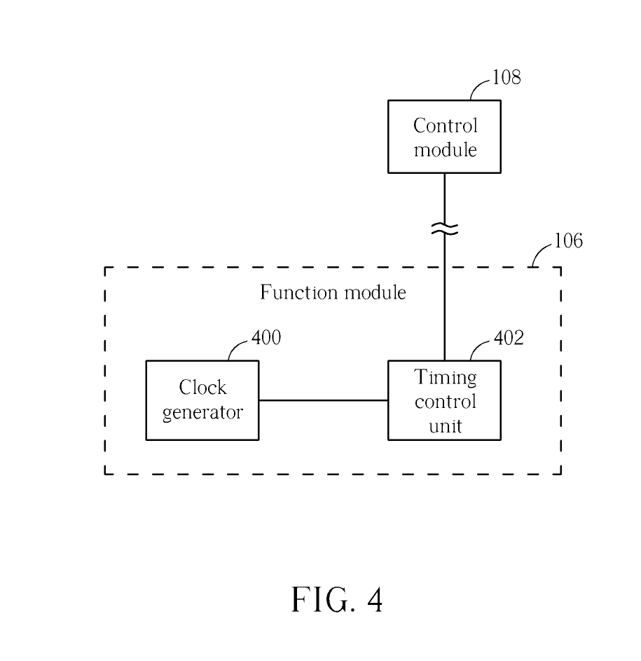

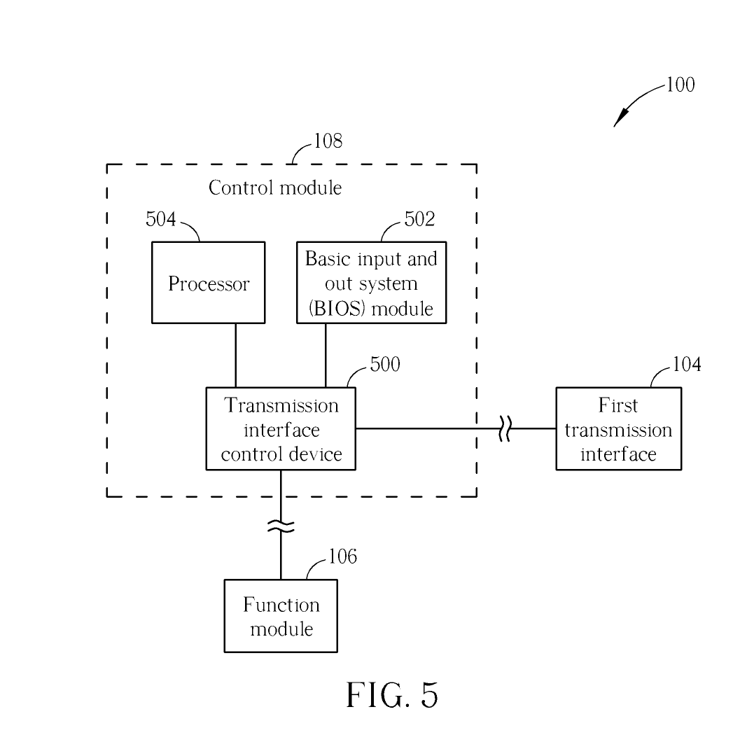

In addition, FIG. 1 only shows the basic structure of the first electronic device 100, and components of the first electronic device 100 can be differed based on different applications. For example, in FIG. 5, the control module 108 is simplified as a combination of a transmission interface control device 500, a basic input and out system (BIOS) module 502 and a processor 504. The transmission interface control device 500 controls the connection between the first transmission interface 104 and the second transmission interface 110. The BIOS module 502 is coupled to the transmission interface control device 500 for storing a specific program corresponding to the first function. The processor 504 is the operation core of the first electronic device 100 for executing programs. More specifically, the processor 504 executes the operation program stored in the storage module 112 for controlling the function module 106 to execute the second function when the second transmission interface 110 is coupled to the first transmission interface 104. The processor 504 executes the specific program stored in the BISO module 502 for controlling the function module 106 to execute the first function when the second transmission interface 110 is not coupled to the first transmission interface 104.

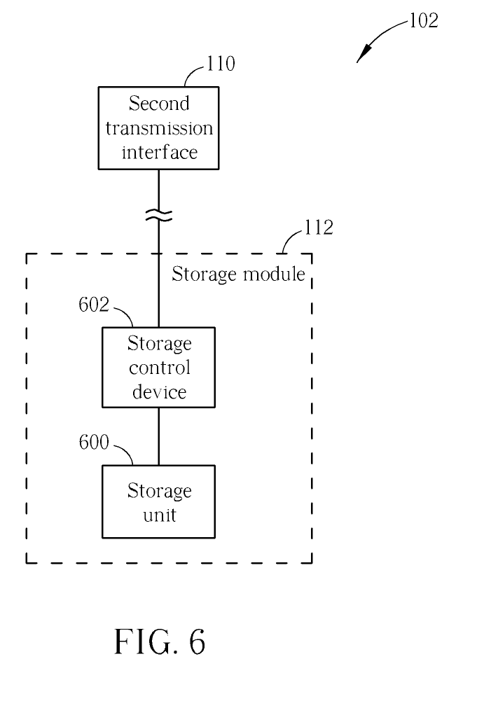

Certainly, FIG. 5 is used to illustrate one of possible structures for the control module 108, and those skilled in the art can implement the control module 108 beyond FIG. 5 based on system requirements. Similarly, the second electronic device 102 can be implemented by other methods; for example, in FIG. 6, the storage module 112 is composed of a storage unit 600 and a storage control device 602. The storage unit 600 can be a non-volatile memory for storing an application program corresponding to the second function. The storage control device 602 outputs the application program stored in the storage unit 600 to the first electronic device 100 to execute the second function when the second transmission interface 110 is coupled to the first transmission interface 104.

To put it briefly, the present invention achieves the extended function beyond the original functions by utilizing all the components included in the first electronic device 100 via the operation program of the second electronic device 102. Therefore, if the first electronic device 100 and the second electronic device 102 refer to a mobile phone and a memory card, the user can use the above-mentioned mechanism to replace the mobile phone with a new mobile phone and insert the memory card storing an operation program of specific function into the mobile phone, such that the mobile phone will achieve new functions beyond the original functions, to help environmental protection and enhance resource recycling. In addition, when a new function is designed, what should be considered includes not only components in the first electronic device 100, but also whether the components are workable. For example, if an image capturing function of the first electronic device 100 is malfunctioned, the electronic system 10 inevitably fails to achieve an automatic recording function. In other words, if an old mobile phone has a fault in communication function but other functions are workable, it can achieve alarm function, automatic recording function and timing function by the present invention, to help environmental protection and enhance resource recycling.

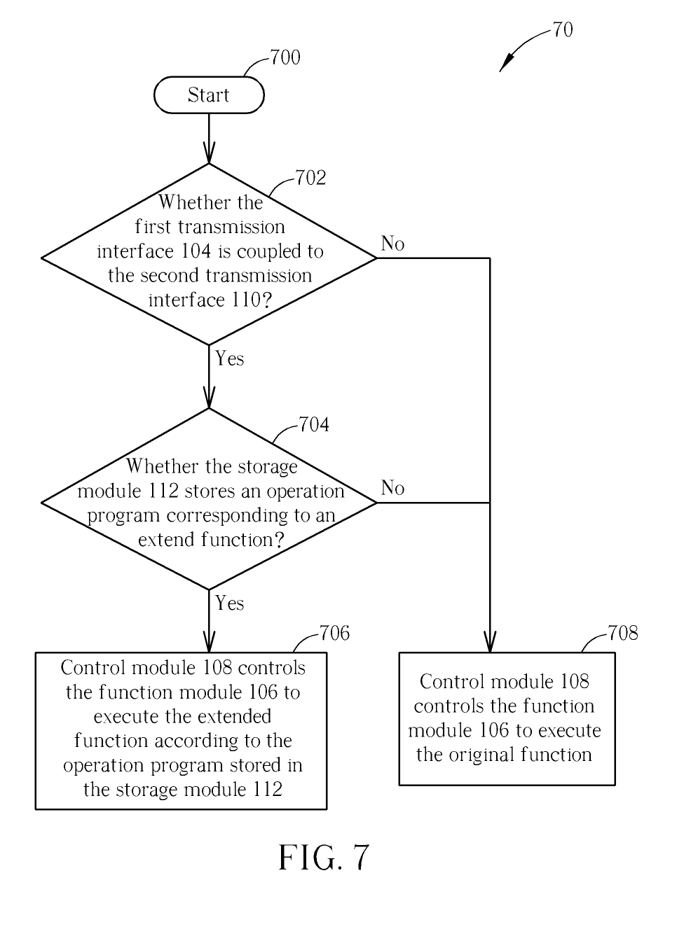

Furthermore, operations of the electronic system 10 can be summarized as an operation procedure 70 shown in FIG. 7. The operation procedure 70 includes the following steps:

Step 700: Start.

Step 702: The control module 108 determines whether the first transmission interface 104 is coupled to the second transmission interface 110. If the first transmission interface 104 is coupled to the second transmission interface 110, go to step 704; else, go to step 708.

Step 704: The control module 108 determines whether the storage module 112 stores an operation program corresponding to an extend function. If the storage module 112 stores an operation program corresponding to an extend function, go to step 706; else, go to step 708.

Step 706: The control module 108 controls the function module 106 to execute the extended function according to the operation program stored in the storage module 112.

Step 708: The control module 108 controls the function module 106 to execute the original function.

Therefore, according to the operation procedure 70, after the first transmission interface 104 is coupled to the second transmission interface 110, if the storage module 112 stores an operation program corresponding to an extend function, the control module 108 can control the function module 106 to execute the extended function according to the operation program. Otherwise, the function module 106 executes the original function.

In the prior art, if a customer purchases a new mobile phone or the old mobile phone is malfunctioned, the old mobile phone becomes useless, resulting in recycling or redundancy, and creating environmental problems and resource waste. In comparison, using the mechanism of the present invention, the customer can insert a memory card storing operation program of specific function into the old mobile phone, and the old mobile phone can achieve new functions beyond the original functions, to help environmental protection and enhance resource recycling.

Those skilled in the art will readily observe that numerous modifications and alterations of the device and method may be made while retaining the teachings of the invention.

What is claimed is:

1. An electronic system with extended functions comprising:
a first electronic device comprising:
a first transmission interface;
a function module, for executing a first function; and
a control module, coupled to the first transmission interface and the function module, for controlling the first transmission interface and the function module; and
a second electronic device comprising:
a second transmission interface, for being coupled to the first transmission interface, for exchanging signals with the first electronic device; and
a storage module, coupled to the second transmission interface, for storing an operation program;
wherein the control module controls the function module to execute a second function according to the operation program stored in the storage module, when the second transmission interface is coupled to the first transmission interface.

2. The electronic system of claim 1, wherein the first transmission interface and the second transmission interface exchange signals via a wire or wireless communication method.

3. The electronic system of claim 1, wherein the first electronic device further comprises an power supply module for supplying electrical power to the first transmission interface, the function module and the control module, and utilizing a wire communication method for supplying electrical power to the second transmission interface and the storage module when the second transmission interface is coupled to the first transmission interface.

4. The electronic system of claim 1, wherein the first electronic device further comprises a power supply module for supplying electrical power to the first transmission interface, the function module and the control module, and utilizing an electromagnetic induction method for supplying electrical power to the second transmission interface and the storage module when the second transmission interface is coupled to the first transmission interface.

5. The electronic system of claim 1, wherein the first electronic device further comprises a power supply module for supplying electrical power to the first transmission interface, the function module and the control module, and the second electronic device further comprises a second power supply module for supplying electrical power to the second transmission interface and the storage module.

6. The electronic system of claim 1, wherein the first function is a voice signal processing function, and the function module comprises:
a microphone, for receiving voice signals;
a speaker, for outputting voice signals;
an audio control device, coupled to the microphone and the speaker, for controlling the microphone and the speaker;
wherein the second function is an alarm function, and the control module controls the audio control device to drive the speaker to output an alarm signal when a volume of the voice signals received by the microphone is greater than a predefined value according to the operation program stored in the storage module.

7. The electronic system of claim 1, wherein the first function is an image processing function, and the function module comprises:
an image capture unit, for capturing an image signal; and
an image signal processor, coupled to the image capture unit, for processing the image signal captured by the image capture unit, to generate a processing result;
wherein the second function is an automatic recording function, and the control module drives the image capture unit to recorder the captured image signal when the processing result of the image signal processor indicates that a variation degree of the image signal captured by the image capture unit is greater than a predefined value according to the operation program stored in the storage module.

8. The electronic system of claim 1, wherein the first function is a clock generating function, and the function module comprises:
a clock generator, for generating a clock signal; and
a timing control unit, coupled to the clock generator, for controlling the clock generator;
wherein the second function is a timing function, and the control module controls the timing control unit to count time based on the clock signal when the second transmission interface is coupled to the first transmission interface according to the operation program stored in the storage module.

9. The electronic system of claim 8, wherein the function module further comprises a display module, and the control module is further utilized for controlling the display module to display a timing result of the timing control unit.

10. The electronic system of claim 1, wherein the control module comprises:
a transmission interface control device, for controlling connection between the first transmission interface and the second transmission interface;
a basic input and output system module, coupled to the transmission interface control device, for storing a specific program corresponding to the first function, and
a processor, coupled to the transmission interface control device, for executing the operation program stored in the storage module to control the function module to execute the second function when the second transmission interface is coupled to the first transmission interface; and executing the specific program stored in the basic input and output system module to control the function module to execute the first function when the second transmission interface is not coupled to the first transmission interface.

11. The electronic system of claim 1, wherein the storage module comprises:
a storage unit, for storing the operation program; and
a storage control device, coupled to the storage unit and the second transmission interface, for outputting the operation program stored in the storage unit to the first electronic device when the second transmission interface is coupled to the first transmission interface.

12. The electronic system of claim 1, wherein the first electronic device is a mobile phone, and the second electronic device is a memory card.

13. A method for extending functions in a first electronic device utilized for executing a first function, the method comprising:
a second electronic device storing an operation program corresponding to a second function; and
the first electronic device executing the second function according to the operation program when the second electronic device is coupled to the first electronic device.

14. The method of claim 13, wherein the second electronic device is coupled to the first electronic device via a wire or wireless communication method.

15. The method of claim 13 further comprising the first electronic device executing the first function when the second electronic device is not coupled to the first electronic device.

16. The method of claim 13, wherein the first electronic device is a mobile phone, and the second electronic device is a memory card.
